(19) United States
(12) Patent Application Publication
(10) Pub. No.: US 2026/0261365 A1
(43) Pub. Date: Sep. 3, 2026

(54) METHOD FOR BEACON FRAGMENTATION

(71) Applicant: MEDIATEK INC., Hsinchu City (TW)

(72) Inventors: Abhijeet Singh Katiyar, Noida (IN); Shivam Ahuja, Noida (IN); Vishal Bhargava, Noida (IN); Rahul Mahajan, Noida (IN)

(73) Assignee: MEDIATEK INC., Hsinchu City (TW)

(21) Appl. No.: 19/177,648

(22) Filed: Apr. 14, 2025

(30) Foreign Application Priority Data
Mar. 3, 2025 (IN) 202521018660

(51) Int. Cl. H04L 1/1607; H04L 5/00; H04L 69/22

(52) U.S. Cl. CPC H04L 1/1607; H04L 5/0053; H04L 69/22

(57) ABSTRACT

A method for fragmenting a beacon frame into a plurality of fragments, including: determining a DTIM period for the beacon frame; fragmenting the beacon frame into the plurality of fragments according to the value of the DTIM period; and sending each fragment of the plurality of fragments at regular intervals within the DTIM period; wherein the value of the DTIM period is two or greater.

### BACKGROUND

The present invention is directed to a beacon frame sent by an access point, and more particularly, to a method for fragmenting a beacon frame sent by an access point.

When an access point (AP) wishes to advertise that it is available for network connection, it regularly sends out a management frame known as a beacon frame. This beacon frame contains information regarding the network, such as security information, a unique identifier of the network, a received signal strength indicator (RSSI) etc.

Enhancements to the Wi-Fi protocol enable a client device (STA) to learn more about a network before determining to connect. This involves adding information elements to the beacon frames, examples of which are shown in the table below.

| Information element name | Description |
|---|---|
| Extended Capabilities | Indicates whether an AP supports |
| | 802.11U interworking features |
| Interworking | Identifies the interworking service |
| | capabilities of the AP or client |
| Advertisement Protocol | Identifies the network's support for |
| | particular advertisement protocols, |
| | such as ANPQ, which allow the client |
| | to learn more about the network by |
| | querying the AP prior to forming a |
| | connection |
| Roaming Consortium | Identifies service providers or |
| | groups of roaming partners whose |
| | security credentials can be used to |
| | connect to a network |

As wireless communications technology develops, it is expected that new information elements (IEs) will continue to be added to beacon frames in order to increase the amount of information available to a client device. With this increase in size of the beacon frames, more airtime is occupied and the transmission becomes less efficient. At some point, these beacon frames will be too large for a Wi-Fi Internet of Things (IOT) device to process, or may even exceed a maximum packet length. If an AP is broadcasting to many client devices (STAs), some STAs may lack the capability to process the beacon frames if they are too large, resulting in the STAs dropping the beacon frames. Alternately, these STAs would need to disable certain features in order to process the large beacon frames.

### SUMMARY

This in mind, the invention aims to provide a method for fragmenting a beacon frame and transmitting the beacon frame fragments at regular intervals.

A method for fragmenting a beacon frame into a plurality of fragments comprises: determining a DTIM period for the beacon frame; fragmenting the beacon frame into the plurality of fragments according to the value of the DTIM period; and sending each fragment of the plurality of fragments at regular intervals within the DTIM period; wherein the value of the DTIM period is two or greater.

In an embodiment, the number of fragments is equal to the value of the DTIM period. The method further comprises defining a fragment number for each fragment of the plurality of fragments, wherein a first fragment of the plurality of fragments has a fragment number equal to zero, and the fragment number for each successive fragment of the plurality of fragments is incremented by one. When a next beacon frame is fragmented into a next plurality of fragments and sent during a next DTIM period, a first fragment of the next plurality of fragments will have a fragment number equal to zero, and the fragment number for each successive fragment of the next plurality of fragments is incremented by one.

The method further comprises including a MAC control header in each fragment of the plurality of fragments; for each fragment of the plurality of fragments apart from the last fragment of the plurality of fragments, setting a more fragments bit in a Frame Control field of the MAC header to one; and for the last fragment of the plurality of fragments, setting a more fragments bit in a Frame Control field of the MAC header to zero.

The beacon frame is a DTIM beacon frame. The step of fragmenting the beacon frame into a number of fragments according to the value of the DTIM period further comprises including all mandatory information elements (IEs) of the beacon frame in each of the plurality of fragments.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A illustrates a Frame Control field of a MAC header according to the related art.

FIG. 1B illustrates a Sequence Control field of a MAC header according to the related art.

FIG. 2 illustrates a method of fragmenting beacon frames according to an exemplary embodiment of the present invention.

### DETAILED DESCRIPTION

As detailed above, an access point (AP) will transmit a beacon frame at regular intervals. This beacon frame may be for announcing the SSID to enable STAs to discover the AP's network, or for broadcasting key information to connected STAs. Beacon frames are management frames and contain an information element known as a c indication map (TIM), which can inform a STA about information buffered at the AP. A DTIM beacon is a beacon which is broadcast every specific time interval (or DTIM period), and also contain the TIM IE. The TIM IE contains the following sub-fields: an element ID, a length, a DTIM count, a DTIM period, a bitmap control and a partial bitmap. The value of the DTIM period indicates the number of regular TIM frames which occur between each DTIM beacon, and will always have the same value, no matter which beacon frame it is contained in. The DTIM count, however, is a real-time counter indicating how many frames (including the current frame) will occur before the next DTIM beacon. When the DTIM count equals zero, this indicates the fragment is a first fragment within the DTIM period. For a next successive fragment, the value is then set to a maximum value being the DTIM period minus 1, and then decrements by one for each successive fragment such that a final beacon sent before a next DTIM beacon will have a DTIM count of one.

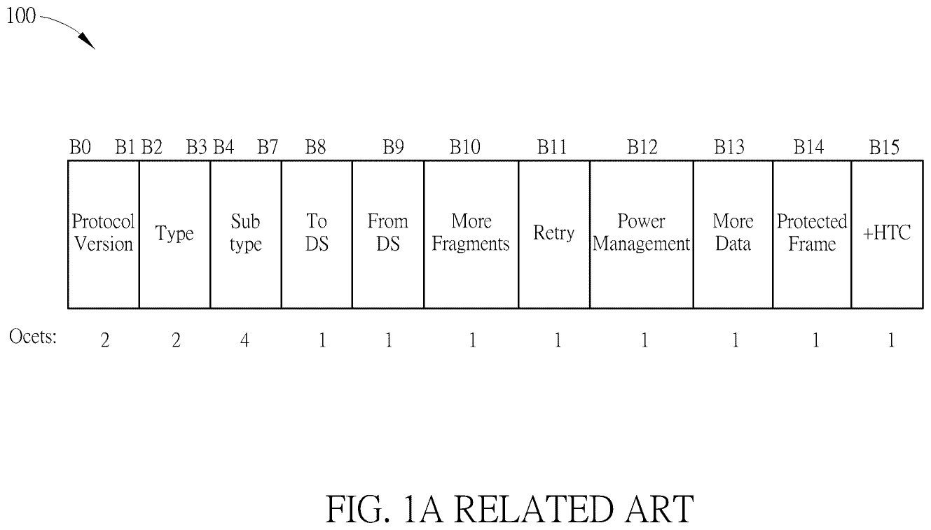

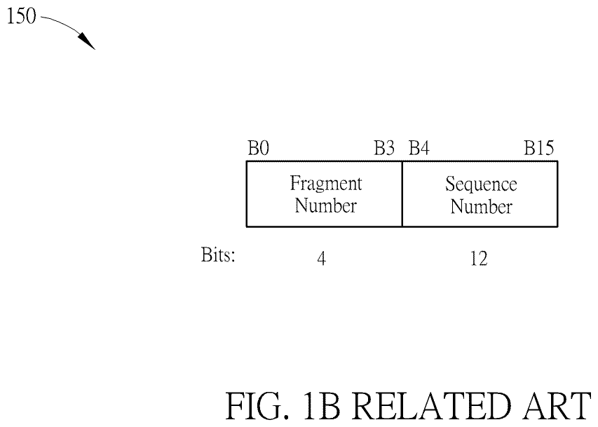

A MAC header will be present in all types of frames, and contains mandatory fields including a Frame Control field, and a Sequence Control field. Refer to FIG. 1A, which is a diagram of a Frame Control field. As shown in the diagram, the Frame Control field includes the following sub-fields: protocol version, type, subtype, To DS, From DS, more fragments, Retry, power management, more data, protected frame and +HTC fields. When the more fragments field is set, this notifies an AP or client device (STA) that a packet to be transmitted will be sent in fragments. At present, the more fragments field is not set for beacon frames.

Refer to FIG. 1B, which illustrates a Sequence Control field comprising a fragment number element and a sequence number element. When a Segment and Reassembly (SAR) bit is not used, the Sequence Control field will be used for re-assembling a fragmented packet. The fragment number element contains four bits. For a first fragment of a particular data packet (MSDU or MMPDU), the fragment number element is set to zero, and then increments by one for each successive fragment of the particular data packet. The sequence number element is a 12-bit number and is assigned to a specific MSDU/MMPDU, such that each fragment has the same sequence number. These two fields enable a receiving device to put the fragments together in the correct order in case they are received out of sequence.

Although the above fragmentation method is not used for beacon frames, as all frames contain the MAC header and therefore contain the Frame Control field and Sequence Control field, the existing standard for packet fragmentation can be applied to beacon frames. By setting the ‘more fragments’ field in the Frame Control field, a receiving device will expect the beacon to be received in fragments.

In order to do so, two new parameters are defined: MF, which stands for more fragments, and FN which stands for fragment number. The DTIM period, DTIM count, and Sequence Number (SN) are also used, as sending of all the beacon fragments should be completed within a DTIM period. The first beacon fragment will be sent at the same time as the actual beacon; however, rather than sending the subsequent fragments back to back, as is done for data packets, the beacon fragments are sent at each interval. Further, the important IEs are put into each of the fragments, to enable a receiving STA when processing the fragments.

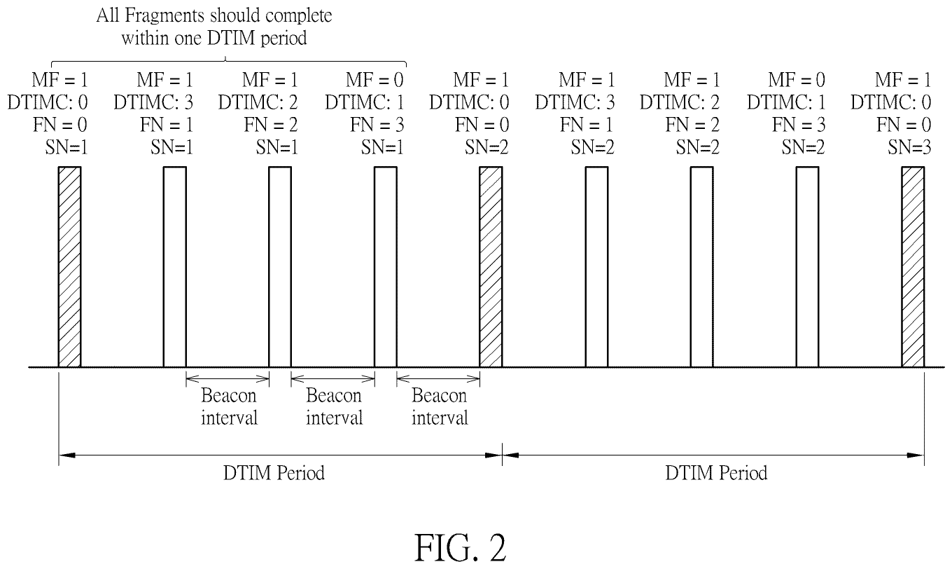

Refer to FIG. 2, which is a diagram illustrating two beacon frames being sent in fragments. Each fragment will contain a MAC header allowing each fragment to set the More Fragments bit, wherein when the number is set to 1, this indicates the fragment is not the final fragment, and when the number is set to 0, this indicates the fragment is the final fragment. In addition, each fragment has a fragment number, wherein a first fragment has a fragment number of zero, and for each subsequent fragment, the fragment number will be incremented by one. The DTIM count and DTIM period are as previously defined. Note that the number of fragments and the size of each fragment are not limited to the example shown in the diagram. As long as the DTIM period is at least equal to two, this indicates that the beacon will be fragmented.

As illustrated in FIG. 2, a DTIM period is equal to 4, meaning four beacon fragments will be sent in each DTIM period. The fragments are sent at regular intervals, defined as a beacon interval. For a first fragment, the fragment number will be zero and the more fragments bit in the Frame Control field of the MAC header will be set to one. The DTIM count is set to zero. For a next successive fragment, the fragment number increments to one, the more fragments bit is still set to one as there are more fragments to be sent, and the DTIM count is set to three. For the next successive fragment, the fragment number increments to two, the more fragments bit is still set to one as there are more fragments to be sent, and the DTIM count decrements to two. For the final fragment, the fragment number increments to three, the more fragments bit is now set to zero as there are no more fragments to be sent, and the DTIM count decrements to one, indicating the end of the DTIM period and the final fragment. The same applies to the next four beacon fragments which are sent within the next DTIM period. In addition, the first four successive fragments will have an SN of one, indicating that all four fragments belong to a first beacon, while the next four successive fragments will have an SN of two, indicating that these four fragments all belong to a second beacon.

As detailed above, the number of beacon fragments is not limited to that shown in FIG. 2. The number of beacon fragments will be according to the DTIM period, and a first fragment of a next beacon frame will be sent after the last fragment of the immediately preceding DTIM beacon.

By sending the beacon fragments at regular intervals, the airtime is optimized effectively as less data is sent each time. The invention is implementation dependent, and therefore does not have to be limited to four beacons; in other embodiments, the beacon frame can be fragmented into two beacon fragments, three beacon fragments, or more than four beacon fragments.

The above method means that an Internet of Things (IoT) device can optimize its limited memory resources, meaning that beacon frames having large sizes can still be processed, thereby preventing the dropping of beacon frames, or the disabling of some features of the IoT device. As each fragment of the beacon frames will include the important information elements (IEs), a client device (STA) can immediately process each fragment when it is received, reducing congestion and improving utilization of the channel. Further, the reduction in size of the beacon frame due to the fragmentation allows for faster transmission which results in lower latency of a network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for fragmenting a beacon frame into a plurality of fragments, the method comprising:
determining a DTIM period for the beacon frame;
fragmenting the beacon frame into the plurality of fragments according to the value of the DTIM period; and
sending each fragment of the plurality of fragments at regular intervals within the DTIM period;
wherein the value of the DTIM period is two or greater.

2. The method of claim 1, wherein the number of fragments is equal to the value of the DTIM period.

3. The method of claim 1, further comprising:
defining a fragment number for each fragment of the beacon frame, wherein a first fragment of the beacon has a fragment number equal to zero, and the fragment number for each successive fragment is incremented by one.

4. The method of claim 1, further comprising:
fragmenting a next beacon frame into a next plurality of fragments; and
sending a first fragment of the next plurality of fragments in a next DTIM period;
wherein a first fragment of the next plurality of fragments will have a fragment number equal to zero, and the fragment number for each successive fragment of the next plurality of fragments is incremented by one.

5. The method of claim 1, wherein the step of fragmenting the beacon frame into the plurality of fragments further comprises:
including a MAC control header in each fragment of the plurality of fragments;
for each fragment of the plurality of fragments apart from the last fragment of the plurality of fragments, setting a more fragments bit in a Frame Control field of the MAC control header to one; and
for the last fragment of the plurality of fragments, setting the more fragments bit in the Frame Control field of the MAC control header to zero.

6. The method of claim 1, wherein the beacon frame is a DTIM beacon frame.

7. The method of claim 1, wherein the step of fragmenting the beacon frame into a number of fragments according to the value of the DTIM period further comprises:
including all mandatory information elements (IEs) of the beacon frame in each of the plurality of fragments.
